(19) United States
(12) Patent Application Publication
(10) Pub. No.: US 2015/0000436 A1
(43) Pub. Date: Jan. 1, 2015

(54) ELECTRONIC DEVICE WITH DISPLAY SUPPORT APPARATUS

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: GUANG-LEI ZHANG, Wuhan (CN); XIAO-ZHONG JING, Wuhan (CN); YI-TING HSIEH, New Taipei (TW); GUANG-YAO LEE, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/945,920

(22) Filed: Jul. 19, 2013

(30) Foreign Application Priority Data
Jun. 28, 2013 (CN) 2013102656167

(51) Int. Cl. F16H 19/08

(52) U.S. Cl. CPC F16H 19/08
USPC 74/89.16

(57) ABSTRACT

An electronic device includes a base, a display unit, a supporting member, a first drive mechanism, a second drive mechanism, and a controller. The first drive mechanism includes a first motor and a first gear assembly. The first motor includes a first drive gear driving the first gear assembly and the second drive mechanism includes a second motor and a second gear assembly. The second motor includes a second drive gear driving the second gear assembly. By operating buttons, the user can change the orientation of the display unit or other supported device, the first and second motors providing power assistance to the user in two planes of movement.

### BACKGROUND

1. Technical Field

The present disclosure relates to electronic devices, and more particularly, to an electronic device with a supporting apparatus for supporting a display of the electronic device.

2. Description of Related Art

An electronic device, such as an all-in-one computer, can includes a display and a supporting apparatus supporting the display. The supporting apparatus usually includes a base and a supporting member. The supporting member includes a first end supporting the display and a second end connected to the base. A shaft is rotatably connected between the second end of the supporting member and the base. However, the supporting member often needs to be rotated manually relative to the base, which is inconvenient in use.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded view of an embodiment of an electronic device, wherein the electronic device includes a supporting member and a first drive mechanism.

FIG. 2 is an enlarged, exploded view of the first drive mechanism of FIG. 1.

FIG. 3 is similar to FIG. 2, but the first drive mechanism is viewed from another perspective.

FIG. 4 is an exploded view of the supporting member of FIG. 1, wherein the supporting member includes a second drive mechanism.

FIG. 5 is an enlarged view of the second drive mechanism of FIG. 4.

FIGS. 6-7 are views of the processes of assembling the second drive mechanism of FIG. 5.

FIG. 8 is an assembled view of the electronic device of FIG. 1.

FIG. 9 is similar to FIG. 8, but shows a different state of use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

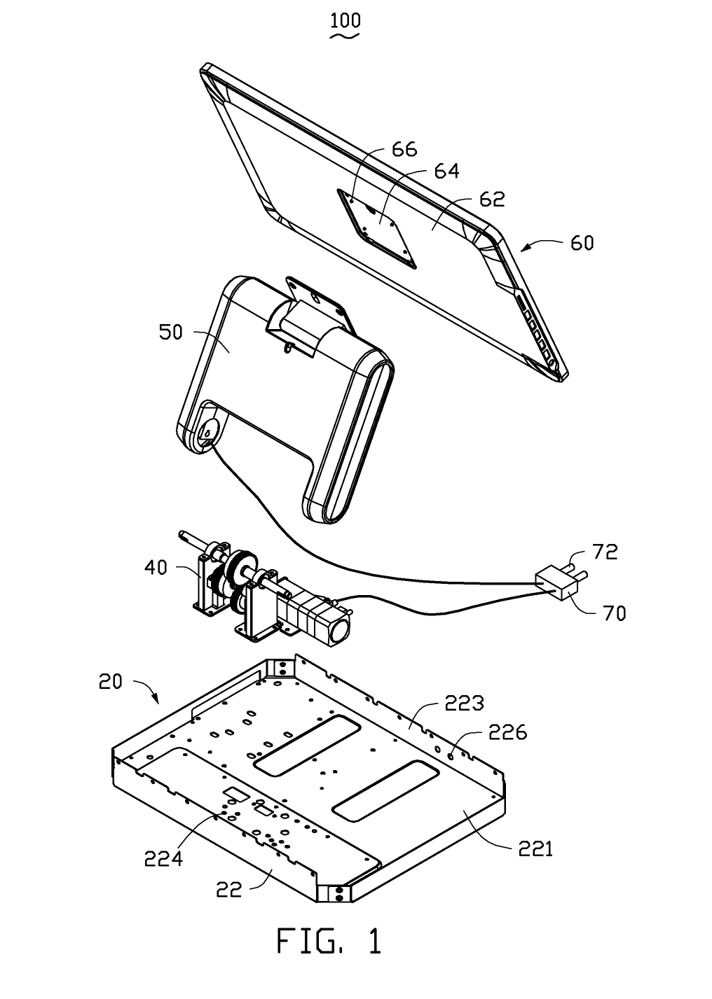

FIG. 1 shows an embodiment of an electronic device 100 including a base 20, a first drive mechanism 40, a supporting member 50, a display unit 60, and a controller 70.

The display unit 60 includes a shell 62. A rear surface of the shell 24 defines a depressed portion 64. A bottom wall of the depressed portion 64 defines a plurality of screw holes 66.

The base 20 includes a bottom plate 221 and a front plate 223 perpendicularly extending up from a front side of the bottom plate 221. A middle of a rear side of the bottom plate 221 defines a plurality of mounting holes 224. An end of the front plate 223 defines a plurality of through holes 226.

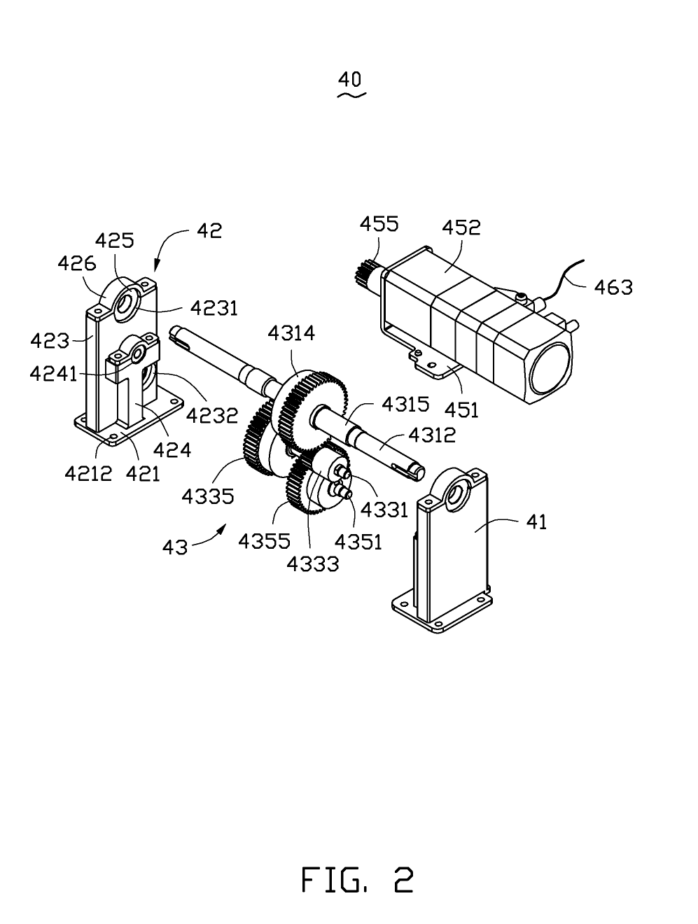

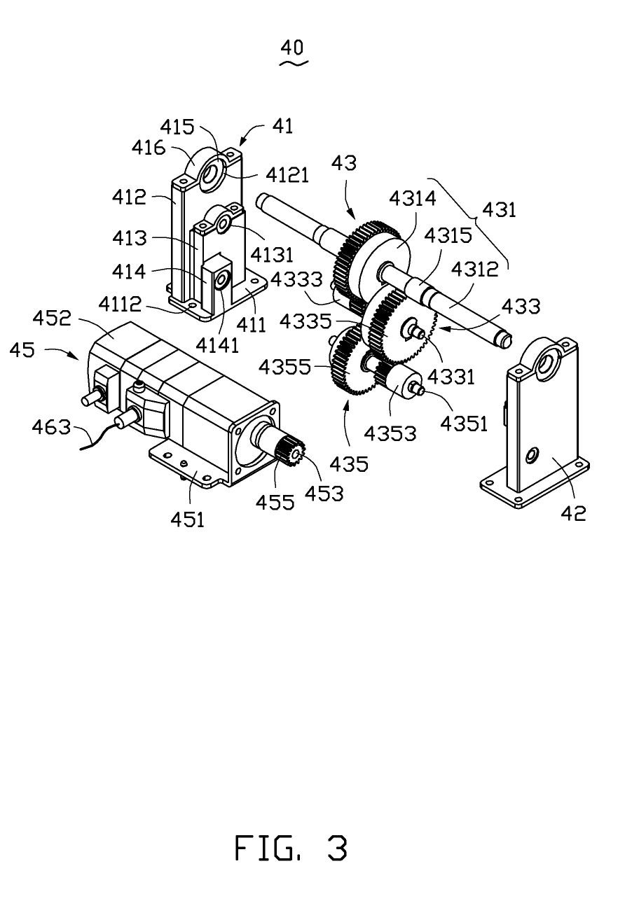

FIG. 2 and FIG. 3 show the first drive mechanism 40 including a first bracket 41, a second bracket 42, a first gear assembly 43, and a first motor 45.

The first bracket 41 includes a mounting plate 411, a first supporting plate 412 perpendicularly extending up from a side of the mounting plate 411, a second supporting plate 413 on the inside of a lower portion of the first supporting plate 412 and connected to the mounting plate 411, a third supporting plate 414 on the inside of a lower portion of the second supporting plate 413 and opposite to the first supporting plate 412, three bearings 415, and two bearing covers 416. A top of the first supporting plate 412 defines a cutout 4121. A top of the second plate 413 defines a cutout 4131. An upper portion of the third supporting plate 414 defines a position hole 4141. The bearings 415 are mounted in the cutouts 4121 and 4131 and the position hole 4141. The bearing covers 416 are mounted on tops of the first and second supporting plates 412 and 413, and secure in place two of the bearings 415. The mounting plate 411 defines a plurality of through holes 4112.

The second bracket 42 includes a mounting plate 421, a fourth supporting plate 423 perpendicularly extending up from a middle of the mounting plate 421, a T-shaped fifth supporting plate 424 protruding from a lower portion of the fourth supporting plate 423 and connected to the mounting plate 421, three bearings 425, and two bearing covers 426. A top of the fourth supporting plate 423 defines a cutout 4231, and a lower portion of the fourth supporting plate 423 defines a position hole 4232. A top of the fifth supporting plate 424 defines a cutout 4241. The bearings 425 are mounted in the cutouts 4231 and 4241, and in the position holes 4232. The bearing covers 426 are mounted on tops of the fourth and fifth supporting plates 423 and 424, for fixing two of the bearings 425. The mounting plate 421 defines a plurality of through holes 4212.

The first gear assembly 43 includes a first gear set 431, a second gear set 433, and a third gear set 435. The first gear set 431 includes a first connecting shaft 4312 and a bull gear 4314 mounted to a middle of the first connecting shaft 4312. Two latching sleeves 4315 are mounted to the two ends of the connecting shaft 4312. The latching sleeves 4315 are located adjacent to the bull gear 4314. The second gear set 433 includes a rotation shaft 4331, a bull gear 4335 mounted to a first end of the rotation shaft 4331, and a pinion 4333 mounted to a second end of the rotation shaft 4331 opposite to the bull gear 4335. The pinion 4333 engages with the bull gear 4314 of the first gear set 431. The third gear set 435 includes a pivot 4351, a pinion 4353 mounted to a first end of the pivot 4351, and a bull gear 4355 mounted to a second end of the pivot 4351 opposite to the pinion 4353. The pinion 4353 of the third gear set 435 engages with the bull gear 4335 of the second gear set 433.

The first motor 45 includes a support 451, a main body 452 mounted on the support 451, a drive shaft 453 extending out from an end of the main body 452, a first drive gear 455 mounted a distal end of the drive shaft 453, and a cable 463.

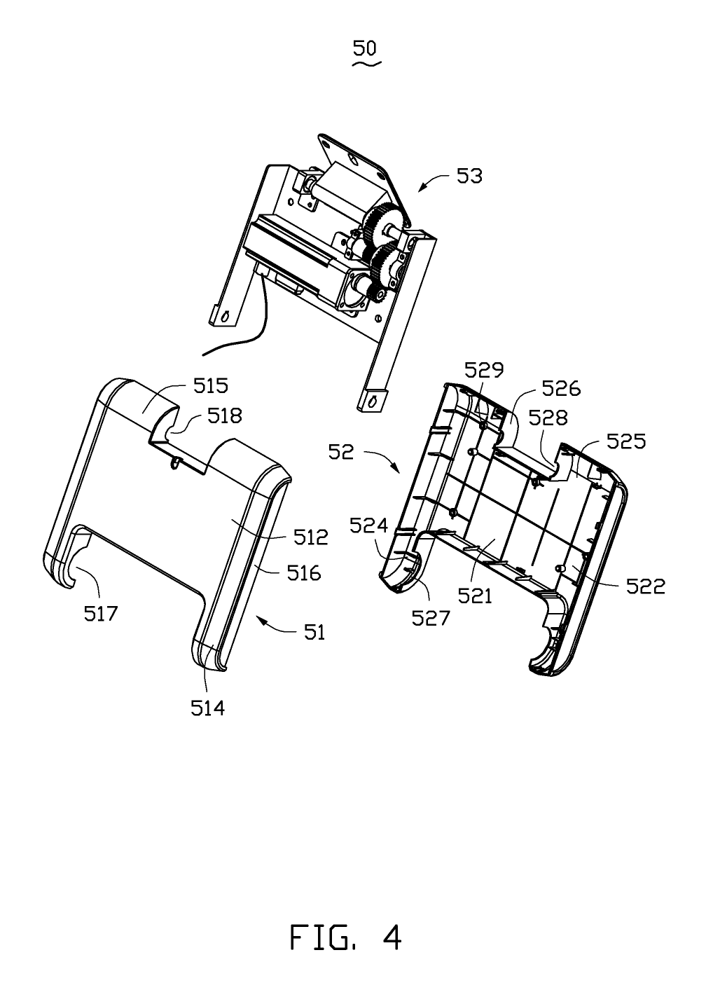

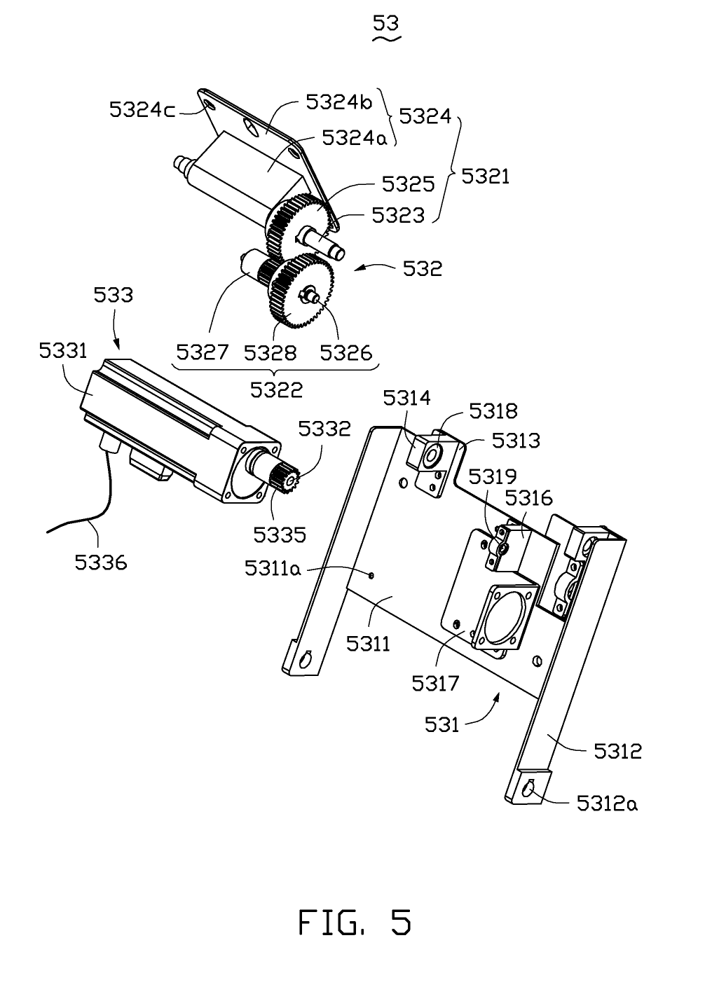

FIG. 4 and FIG. 5 show the supporting member 50 including a substantially H-shaped first cover 51, a substantially H-shaped second cover 52, and a second drive mechanism 53.

The first cover 51 includes a rectangular connecting plate 512, two opposite first connecting portions 514 perpendicularly protruding from two opposite ends of a first side of the connecting plate 512, two opposite second connecting portions 515 perpendicularly protruding from two opposite ends of a second side of the connecting plate 512 away from the first connecting portions 514, and a flange 516 protruding from sides of the connecting plate 512, the first connecting portions 514, and the second connecting portions 515. The flange 516 between the first connecting portions 514 defines two opposite first cutouts 517. The flange 516 between the second connecting portions 515 defines two opposite second cutouts 518.

The second cover 52 includes a rectangular connecting plate 522, two opposite first connecting portions 524 perpendicularly protruding from two opposite ends of a first side of the connecting plate 522, two opposite second connecting portions 525 perpendicularly protruding from two opposite ends of a second side of the connecting plate 522 away from the first connecting portions 524, and a flange 526 protruding from sides of the connecting plate 522, the first connecting portions 524, and the second connecting portions 525. The flange 526 between the first connecting portions 524 defines two opposite first cutouts 527. The flange 516 between the second connecting portions 525 defines two opposite second cutouts 528. The connecting plate 522, the first connecting portions 524, the second connecting portions 525, and the flange 526 cooperatively bound a receiving space 521. An inner wall of the second cover 52 defines a plurality of screw holes 529.

FIG. 5 shows the second drive mechanism 53 including a third bracket 531, a second gear assembly 532, and a second motor 533.

The third bracket 531 includes a rectangular mounting plate 5311, two extending plates 5312 perpendicularly extending from two opposite ends of the mounting plate 5311 and adjacent to a first side of the extending plates, two extending pieces 5313 perpendicularly extending from two opposite ends of a second side of the mounting plate 5311 opposite to the extending plates 5312, two first supporting blocks 5314 mounted on the extending pieces 5313, two second supporting blocks 5316 mounted on the mounting plate 5311, and a support 5317 adjacent to the second supporting blocks 5316 and mounted on the mounting plate 5311. The second supporting blocks 5316 are located between the first supporting blocks 5314 and the support 5317. Two opposite bearings 5318 are mounted in the first supporting blocks 5314. Two opposite bearings 5319 are mounted in the second supporting blocks 5316. Distal ends of the extending plates 5312 define two opposite position holes 5312a. The mounting plate 5311 defines a plurality of through holes 5311a.

The second gear assembly 532 includes a fourth gear set 5321 and a fifth gear set 5322. The fourth gear set 5321 includes a second connecting shaft 5323, a connecting member 5324 mounted to a first end of the second connecting shaft 5323, and a bull gear 5325 mounted to a second end of the second connecting shaft 5323 opposite to the connecting member 5324. The fifth gear set 5322 includes a pivot 5326, a pinion 5327 mounted to a first end of the pivot 5326, and a bull gear 5328 mounted to a second end of the pivot 5326 opposite to the pinion 5327. The pinion 5327 of the fifth gear set 5322 engages with the bull gear 5325 of the fourth gear set 5321. The connecting member 5324 includes a rotation block 5324a mounted to the second connecting shaft 5323 and a connecting plate 5324b mounted to a side of the rotation block 5324a opposite to the rotation block 5324a. The connecting plate 5324b defines a plurality of through holes 5324c.

The second motor 533 includes a main body 5331, a drive shaft 5332 extending out from an end of the main body 5331, a second drive gear 5335 mounted to a distal end of the drive shaft 5332, and a cable 5336.

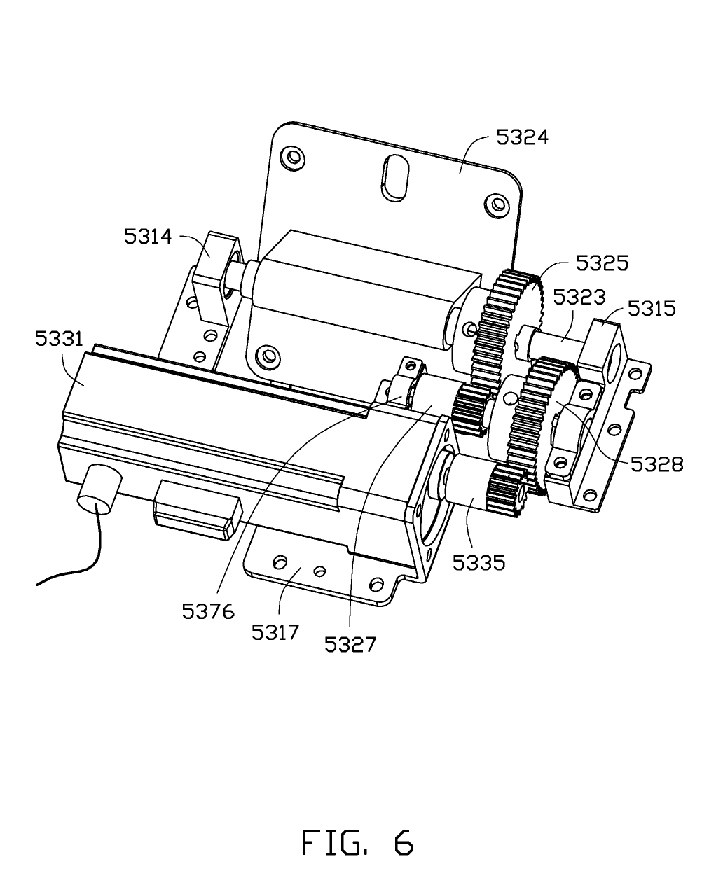

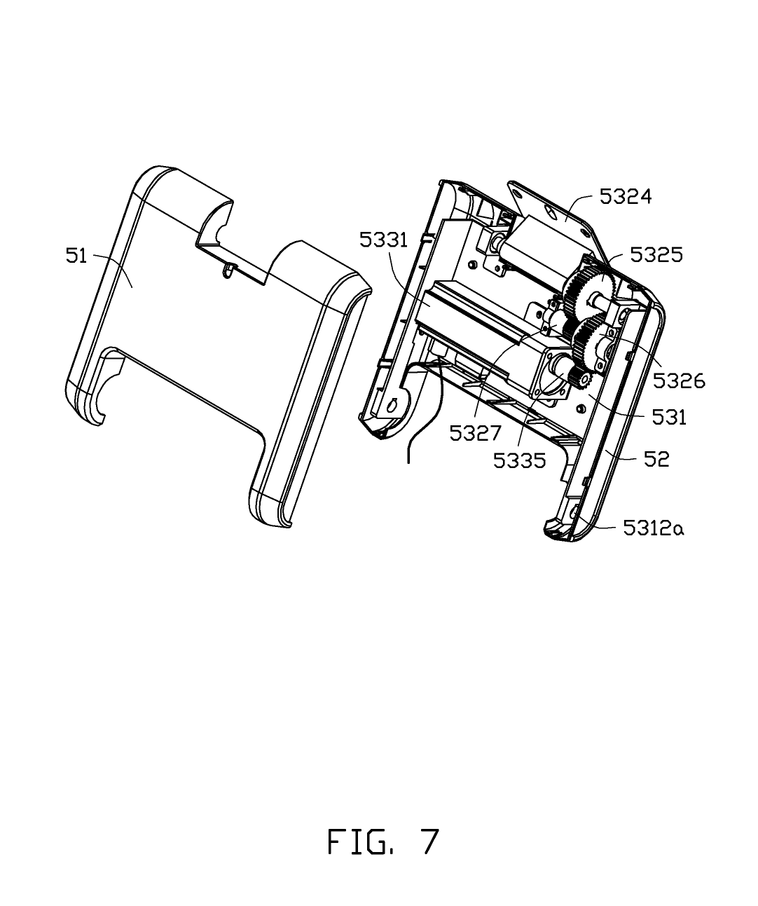

FIG. 6 and FIG. 7 show that in assembling the supporting member 50, two distal ends of the second connecting shaft 5323 are latched in the bearings 5318 of the first supporting blocks 5314. Two distal ends of the pivot 5326 of the fifth gear set 5322 are latched in the bearings 5319 of the second supporting blocks 5316. The second motor 533 is mounted on the support 5317, to allow the second drive gear 5335 to engage with the bull gear 5328 of the fifth gear set 5322. The second drive mechanism 53 is received in the receiving space 521 of the second cover 52. The mounting plate 5311 is mounted on the connecting plate 522 of the second cover 52, and the position holes 5312a of the extending plates 5312 align with the first cutouts 527. Each of a plurality of screws passes through the through holes 5311a of the third bracket 531, to be screwed in the screw holes 529 of the second cover 52. The first cover 51 covers the second cover 52, to allow the first cutouts 517 and the second cutouts 518 of the first cover 51 to be aligned with the first cutout 527 and the second cutout 528 of the second cover 52, respectively. The connecting plate 5324b is exposed out of the first and second covers 51 and 52, and the second connecting shaft 5323 is received between the second cutouts 518 of the first cover 51 and the second cutouts 528 of the second cover 52.

The controller 70 includes a plurality of buttons 72.

In assembling the first drive mechanism 40, the first gear assembly 43 is placed between the first bracket 41 and the second bracket 42, to allow the second supporting plate 413 of the first bracket 41 to face the fifth supporting plate 424 of the second bracket 42. Two distal ends of the first connecting shaft 4312 extend through the bearing 415 mounted in the first supporting plate 412 and the bearing 425 mounted in the top of the fourth supporting plate 423. The latching sleeves 4315 are engaged in the bearing 415 mounted in the first supporting plate 412 and in the bearing 425 mounted in the fourth supporting plate 423. Two distal ends of the rotation shaft 4331 are latched in the bearing 415 mounted in the second supporting plate 413 and in the bearing 425 mounted in the fifth supporting plate 424. Two distal ends of the pivot 4351 are latched in the bearing 415 mounted in the third supporting plate 414 and in the bearing 425 mounted in the bottom of the fourth supporting plate 423.

In assembly of the first drive mechanism 40 to the base 20, a combination of the first bracket 41, the second bracket 42, and the first gear assembly 43 is placed on the bottom plate 221. The bull gear 4355 of the third gear set 435 is adjacent to the front plate 223. Screws extend through the through holes 4112 and 4212 of the mounting plates 411 and 421, to be screwed in the mounting holes 224 of the shell 22. The first motor 45 is placed on the bottom plate 221, to allow the first drive gear 455 to engage with the bull gear 4355 of the third gear set 435. A plurality of fasteners extends through the support 451, to be mounted to the bottom plate 221. The buttons 72 are inserted in the through holes 226 from an inside of the shell 22. The controller 46 is mounted in the shell 22, and the buttons 72 are exposed out of the front plate 223 through the through holes 226. The cable 463 of the first motor 45 and the cable 5336 of the second motor 533 are electrically coupled to the controller 46.

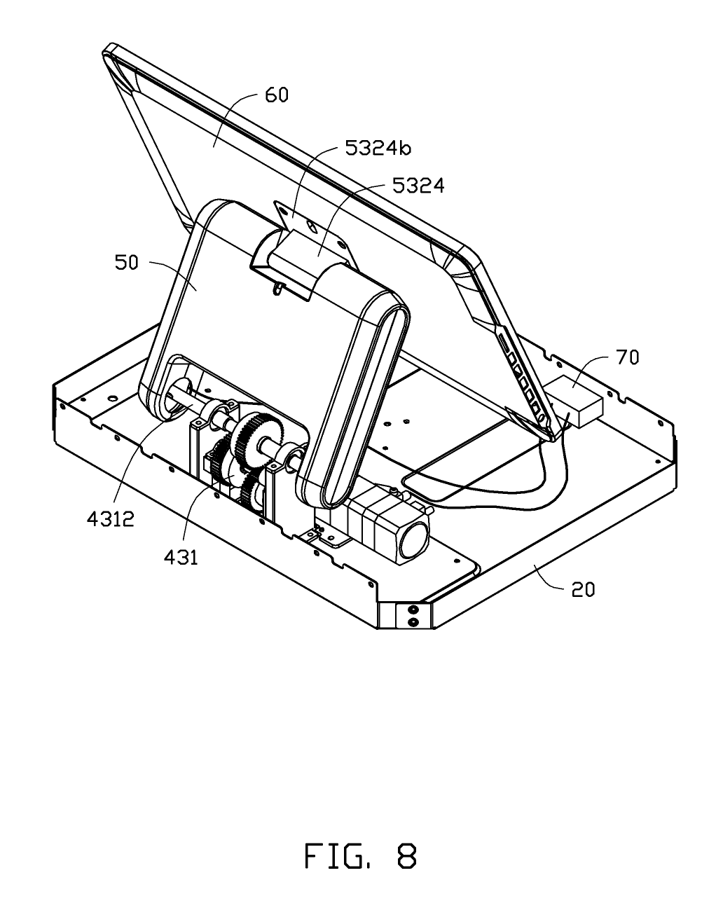

FIG. 8 shows that in assembling the electronic device 100, the first connecting shaft 4312 is placed between the first connecting portions 514 of the supporting member 50. The distal ends of the first connecting shaft 4312 are latched in the position holes 5312a of the third bracket 531. The connecting plate 5324b is received in the depressed portion 64 of the shell 62. A plurality of screws extends through the through holes 5324c of the connecting plate 5324b, to be screwed in the screw holes 66 of the shell 62.

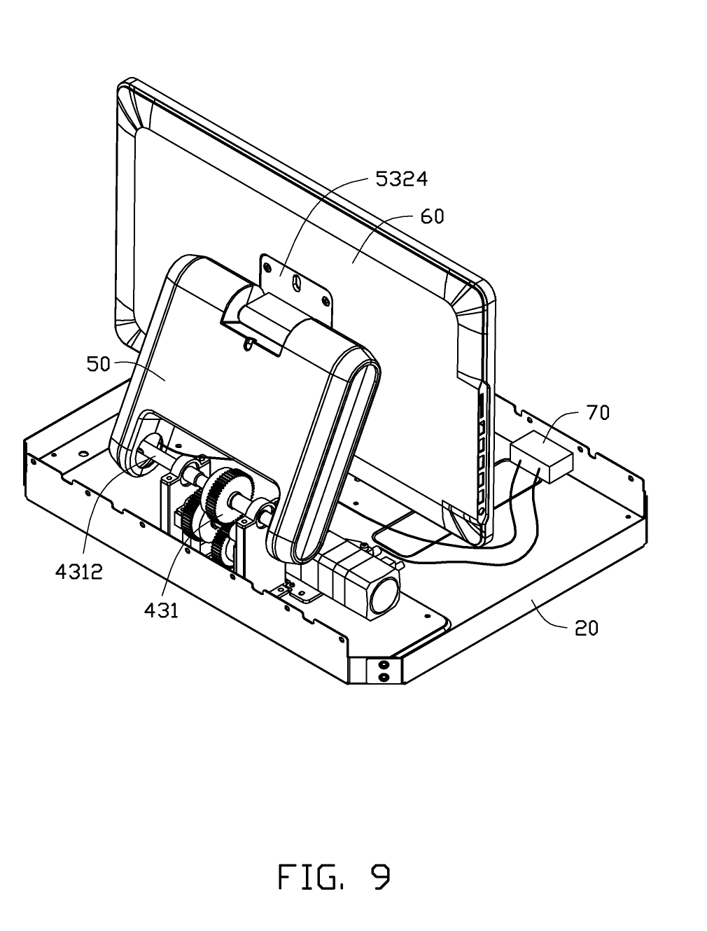

FIG. 9 shows that in use, by operating the buttons 72, the controller 70 controls the first motor 45 and the second motor 533 to operate. The first drive gear 455 and the second drive gear 5335 rotate. The first drive gear 455 drives the first gear assembly 43 to rotate, and the second drive gear 5335 drives the second gear assembly 532 to rotate. The first gear assembly 43 drives the first connecting shaft 4312 to rotate, to allow the supporting member 50 to rotate along with the first connecting shaft 4312. The second gear assembly 532 drives the second connecting shaft 5323 to rotate, to allow the connecting member 5324 to rotate along with the second connecting shaft 5323. Thus, the display unit 60 can be rotated as the user requires.

It is to be understood, however, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A supporting apparatus, comprising:
a base;
a supporting member;
a first drive mechanism connected between the base and the supporting member, and comprising a first motor with a first drive shaft and a first drive gear mounted to the first drive shaft, a first gear assembly connected to the first drive gear and comprising a first connecting shaft connected to the supporting member;
a second drive mechanism connected to the supporting member, and comprising a second motor comprising a second drive shaft and a second drive gear mounted to the second drive shaft, a second gear assembly connected to the second drive gear and comprising a connecting member for being connected to the display unit; and
a controller controlling the first and second motors to operate, thereby allowing the first and second drive gears to drive the first and second gear assemblies to rotate the supporting member and the display unit.

2. The supporting apparatus of claim 1, wherein the first gear assembly comprises a first gear set, a second gear set, and a third gear set, the first gear set comprises a first bull gear mounted to the connecting shaft, the second gear set comprises a rotation shaft, a second bull gear mounted to a first end of the rotation shaft, and a first pinion mounted to a second end of the rotation shaft, the third gear set comprises a pivot, a second pinion mounted to a first end of the pivot, and a third bull gear mounted to a second end of the pivot, the first pinion engages with the first bull gear, the second pinion engages with the second bull gear, and the drive gear engages with the third bull gear.

3. The supporting apparatus of claim 2, wherein the first drive mechanism further comprises a first bracket and a second bracket opposite to the first bracket, the first and second brackets are mounted on the base, the first gear assembly is mounted between the first and second brackets.

4. The supporting apparatus of claim 3, wherein the first bracket comprises a first supporting plate, a second supporting plate protruding from a lower portion of the first supporting plate toward the second bracket, and a third supporting plate protruding from a lower portion of the second supporting plate toward the second bracket, the second bracket comprises a fourth supporting plate opposite to the first supporting plate and a fifth supporting plate protruding from a lower portion of the fourth supporting plate toward the first bracket, the first connecting shaft is connected between the first supporting plate and an upper portion of the fourth supporting plate, the rotation shaft is connected between the second supporting plate and the fifth supporting plate, and the pivot is connected between the third supporting plate and a lower portion of the fourth supporting plate.

5. The supporting apparatus of claim 1, wherein the second gear assembly comprises a fourth gear set and a fifth gear set, the fourth gear set comprises a second connecting shaft and a first bull gear mounted to a first end of the second connecting shaft, the connecting member is mounted to a second end of the second connecting shaft opposite to the first bull gear, the fifth gear set comprises a pivot, a pinion mounted to a first end of the pivot, and a second bull gear mounted to a second end of the pivot opposite to the pinion, the pinion of the fifth gear set engages with the first bull gear of the fourth gear set.

6. The supporting apparatus of claim 5, wherein the second drive mechanism further comprises a third bracket mounted in the supporting member, the third bracket comprises a mounting plate, two first supporting blocks mounted on the mounting plate, and two second supporting blocks mounted on the mounting plate, the second supporting blocks are adjacent to the first supporting blocks, two distal ends of the second connecting shaft are mounted between the first supporting blocks, two distal ends of the pivot are mounted between the second supporting blocks, the second motor is mounted on the mounting plate.

7. The supporting apparatus of claim 6, wherein the mounting plate is rectangular, two spaced extending pieces extending out from a first side of the mounting plate, the first supporting blocks is mounted on the extending pieces, two opposite bearings are mounted to the first supporting blocks, the distal ends of the second connecting shaft are mounted the bearings of the first supporting blocks.

8. The supporting apparatus of claim 6, wherein the second supporting blocks are located between the first supporting blocks, two opposite bearings are mounted to the second supporting blocks, the distal ends of the pivot of the fifth gear set are mounted in the bearings of the second supporting blocks.

9. The supporting apparatus of claim 7, wherein two opposite extending plates extending out from a second side of the mounting plate opposite to the extending pieces, distal ends of the extending plates define two opposite position holes, the distal ends of the first connecting shaft are latched in the position holes of the extending plates.

10. The supporting apparatus of claim 5, wherein the connecting member comprises a rotation block mounted to the second connecting shaft and a connecting plate mounted to the rotation block opposite to the second connecting shaft.

11. An electronic device, comprising:
a base;
a display unit;
a supporting member;
a first drive mechanism connected between the base and the supporting member, and comprising a first motor with a first drive shaft and a first drive gear mounted to the first drive shaft, a first gear assembly connected to the first drive gear and comprising a first connecting shaft connected to the supporting member;
a second drive mechanism connected to the supporting member, and comprising a second motor comprising a second drive shaft and a second drive gear mounted to the second drive shaft, a second gear assembly connected to the second drive gear and comprising a connecting member for being connected to the display unit; and
a controller controlling the first and second motors to operate, thereby allowing the first and second drive gears to drive the first and second gear assemblies to rotate the supporting member and the display unit.

12. The electronic device of claim 11, wherein the first gear assembly comprises a first gear set, a second gear set, and a third gear set, the first gear set comprises a first bull gear mounted to the connecting shaft, the second gear set comprises a rotation shaft, a second bull gear mounted to a first end of the rotation shaft, and a first pinion mounted to a second end of the rotation shaft, the third gear set comprises a pivot, a second pinion mount to a first end of the pivot, and a third bull gear mounted to a second end of the pivot, the first pinion engages with the first bull gear, the second pinion engages with the second bull gear, and the drive gear engages with the third bull gear.

13. The electronic device of claim 12, wherein the first drive mechanism further comprises a first bracket and a second bracket opposite to the first bracket, the first and second brackets are mounted on the base, the first gear assembly is mounted between the first and second brackets.

14. The electronic device of claim 13, wherein the first bracket comprises a first supporting plate, a second supporting plate protruding from a lower portion of the first supporting plate toward the second bracket, and a third supporting plate protruding from a lower portion of the second supporting plate toward the second bracket, the second bracket comprises a fourth supporting plate opposite to the first supporting plate and a fifth supporting plate protruding from a lower portion of the fourth supporting plate toward the first bracket, the first connecting shaft is connected between the first supporting plate and an upper portion of the fourth supporting plate, the rotation shaft is connected between the second supporting plate and the fifth supporting plate, and the pivot is connected between the third supporting plate and a lower portion of the fourth supporting plate.

15. The electronic device of claim 11, wherein the second gear assembly comprises a fourth gear set and a fifth gear set, the fourth gear set comprises a second connecting shaft and a first bull gear mounted to a first end of the second connecting shaft, the connecting member is mounted to a second end of the second connecting shaft opposite to the first bull gear, the first gear set comprises a pivot, a pinion mounted to a first end of the pivot, and a second bull gear mounted to a second end of the pivot opposite to the pinion, the pinion of the fifth gear set is engaged with the first bull gear of the fourth gear set.

16. The electronic device of claim 15, wherein the second drive mechanism further comprises a third bracket mounted in the supporting member, the third bracket comprises a mounting plate, two first supporting blocks mounted on the mounting plate, two second supporting blocks mounted on the mounting plate, the second supporting blocks are adjacent to the first supporting blocks, two distal ends of the second connecting shaft are mounted between the first supporting blocks, two distal ends of the pivot are mounted between the second supporting blocks, and the second motor is mounted on the mounting plate.

17. The electronic device of claim 16, wherein the mounting plate is rectangular, two spaced extending pieces extending out from a first side of the mounting plate, the first supporting blocks are mounted on the extending pieces, two opposite bearings are mounted in the first supporting blocks, the distal ends of the second connecting shaft are latched in the bearings of the first supporting blocks.

18. The electronic device of claim 16, wherein the second supporting blocks are located between the first supporting blocks, two opposite bearings are mounted in the second supporting blocks, the distal ends of the pivot of the fifth gear set are latched in the bearings of the second supporting blocks.

19. The electronic device of claim 16, wherein two opposite extending plates extending out from a second side of the mounting plate opposite to the extending pieces, distal ends of the extending plates define two opposite position holes, the distal ends of the first connecting shaft are latched in the position holes of the extending plates of the pair of first supporting blocks.

20. The electronic device of claim 15, wherein the connecting member comprises a rotation block mounted to the second connecting shaft and a connecting plate mounted to the rotation block opposite to the second connecting shaft, the connecting plate is mounted to the display unit.
